(19) United States
(12) Patent Application Publication
(10) Pub. No.: US 2023/0399245 A1
(43) Pub. Date: Dec. 14, 2023

(54) PROCESS AND SYSTEM INCLUDING PRESSURE RETARDED OSMOSIS MEMBRANE FOR INDIRECT SEAWATER ELECTROLYSIS

(71) Applicant: Qatar Foundation for Education, Science and Community Development, Doha (QA)

(72) Inventors: Ahmed Abdel-Wahab, Doha (QA); Ahmed Badreldin, Doha (QA); Khaled Elsaid, Doha (QA); Ahmed Abdala, Doha (QA)

(21) Appl. No.: 18/208,004

(22) Filed: Jun. 9, 2023

Related U.S. Application Data
(60) Provisional application No. 63/366,089, filed on Jun. 9, 2022.

(51) Int. Cl. C02F 1/44; B01D 61/00; B01D 61/42; C02F 1/46; C02F 1/461

(52) U.S. Cl. CPC C02F 1/445; B01D 61/0022; B01D 61/005; B01D 61/427; C02F 1/4604; C02F 1/46104; C02F 2103/08

(57) ABSTRACT

A process and system for indirect seawater, and other contaminated waters, electrolysis are provided. The system includes a pressure retarded osmosis unit including a semipermeable membrane, and a high pressure electrolyzer unit including an anode and a cathode, with an osmotic agent solution being circulated at high pressure between the draw side of the pressure retarded osmosis unit and the electrolyzer unit. The osmotic agent solution is diluted in the PRO unit as molecular water is drawn into it from the feed solution side through the semipermeable PRO membrane, and it is concentrated in the electrolyzer unit as molecular water is removed by electrolysis. The PRO process supplies the electrolyzer with the required molecular water for electrolysis and maintains a high pressure of the electrolyzer feed.

### CROSS-REFERENCE TO RELATED APPLICATION

The present disclosure claims priority to U.S. Provisional Patent Application 63/366,089 having a filing date of Jun. 9, 2022, the entirety of which is incorporated herein.

### BACKGROUND

Conventional water electrolyzers rely on purified fresh water supply. However, many countries have very limited fresh water resources and depend on seawater desalination for domestic and industrial water supply. Seawater is an abundant water source and therefore, if it can be used as the electrolyzer water source, it would provide a nearly unlimited source of water for H₂ production from water splitting. However, direct seawater electrolysis faces several major challenges.

First, the presence of chloride ions in seawater introduces an undesired side reaction, the chlorine evolution reaction (CER), which competes with the desired oxygen evolution reaction (OER) at the electrolyzer anode. CER is more kinetically favorable than the OER because it involves only two-electron transfer steps, while OER involves four-electron transfer steps. CER products (i.e., ClO⁻ ions in alkaline conditions, HClO in neutral pH conditions, and Cl₂ gas in acidic conditions) are toxic and pose environmental issues and as a result should be suppressed. Second, the high chloride concentration in seawater promotes corrosion of the electrolyzer metal components and deactivation and performance deterioration.

Third, the presence of magnesium (Mg) and calcium (Ca) ions in seawater results in the formation of solid precipitates such as magnesium hydroxide (Mg(OH)₂), calcium carbonate (CaCO₃), and calcium hydroxide (Ca(OH)₂) on the electrode surfaces and cell dividers due to the alkaline nature at the cathode. This normally requires the removal of Mg and Ca from the water prior to the electrolysis process, but this adds cost and produces solid waste. Fourth, as water is converted to H₂ and O₂, salts accumulate inside the electrolyzer. This can be avoided by operating the electrolyzer as a steady-state continuous flow reactor system. However, this will require continuous blowdown of concentrated seawater (i.e., brine) from the electrolyzer, and consequently continuous feed of fresh seawater and pH buffer. This operational scheme will involve additional costs associated with pretreatment and pumping of fresh seawater feed to the electrolyzer. Also, the scheme will require continuous additions of chemicals that are used to maintain adequate pH buffering capacity in the electrolyzer and consequently a high cost of chemicals due to the disposal of buffer with the discharged brine. Regeneration of buffer from the brine could be very costly, and the disposal of buffer-containing brine back into the sea can cause adverse environmental impacts. Additionally, seawater contains other impurities that can deposit on the surfaces of electrodes and electrolyzer components leading to their deterioration. Also, incompatibility of seawater with membranes used in conventional water electrolyzers (WE) creates challenges for electrolyzer operation such as biofouling and/or production of pH gradients that rapidly develop across the membrane due to reactions at the electrodes. In summary, several significant challenges hinder direct seawater splitting systems.

### SUMMARY

According to one non-limiting aspect of the present disclosure, an example embodiment of a system for indirect seawater electrolysis is provided. In one embodiment, the system includes a pressure retarded osmosis unit (PRO) that includes a semipermeable membrane housed in the PRO unit between a stream of seawater or other contaminated water (feed solution) and another stream of water containing an osmotic agent (draw solution) that has higher osmotic pressure and higher hydrostatic pressure than the osmotic and hydrostatic pressures, respectively, of the feed side, and a high pressure water electrolyzer unit (WE) including an anode and a cathode coupled to the PRO unit. The PRO membrane in configured to allow molecular water to flow through it and prevent one or more of the contaminants present in the feed solution from crossing to the draw solution side. Also, it is configured to exclude one or more of the osmotic agent species present in the draw solution from crossing to the feed solution side. In this combined PRO-WE system, the PRO draw solution is circulated between the PRO draw side and the WE at high hydrostatic pressure. It is diluted in the PRO unit as molecular water is drawn into it from the feed solution side through the semipermeable PRO membrane. It is concentrated in the WE unit as molecular water is removed by electrolysis. This approach allows feeding the electrolyzer with molecular water drawn from seawater or other contaminated waters through the PRO membrane, but with excluding one or more of the contaminants present in these source waters from entering the electrolyzer. Also, it maintains a high pressure in the WE feed. This is because the PRO process maintains a high pressure of the draw solution loop between PRO and WE due to the effect of osmosis drawing water through the membrane against the hydrostatic pressure gradient. This augments the volumetric flowrate of the pressurized draw solution stream flowing from the PRO unit into the electrolyzer, and maintains its high pressure. The effectiveness of the net driving force for molecular water permeation through the PRO membrane from the feed side to the draw side decreases with an increase in the applied hydrostatic pressure on the draw side. However, despite this, the utilization of PRO with high-pressure molecular water flux in the WE system can offer significant cost-reduction. Since H₂ gas is commonly stored, transported, or used at high pressure, operating the WE at high pressure directly reduces downstream processing costs associated with H₂ compression. The optimal operating pressure ranges for traditional WE systems align with the permissible hydrostatic pressure ranges of PRO semipermeable membranes. The present disclosure encompasses various interrelated products, alternative solutions, and multiple applications of the disclosed systems and articles, without limitation. A high pressure WE unit, including an anode and a cathode, a gas-impermeable separator in between the electrodes, coupled to the PRO unit draw side, enables water splitting wherein the split water is originally sourced from the molecular water flux from the feed to the draw side of the PRO unit, and maintains high pressure in the electrolyzer feed.

In another aspect of the present disclosure, which may be combined with any other aspect listed herein unless specified otherwise, the hydrostatic pressure of the draw solution is higher than the hydrostatic pressure of the feed solution, but the hydrostatic pressure difference (ΔP) between the draw side and the feed side of the PRO is lower than the difference in osmotic pressures between the draw and feed solutions (Δπ). In another aspect of the present disclosure, which may be combined with any other aspect listed herein unless specified otherwise, the draw solution is diluted in the PRO unit as water is drawn into it spontaneously from the feed solution side of the PRO through the PRO membranes by effect of the net osmotic pressure difference (Δπ-ΔP) between the draw side and the feed side of the PRO unit.

In another aspect of the present disclosure, which may be combined with any other aspect listed herein unless specified otherwise, the draw solution is configured to flow between the draw side of the PRO unit and the high pressure WE unit.

In another aspect of the present disclosure, which may be combined with any other aspect listed herein unless specified otherwise, the draw solution is diluted by molecular water influx from the PRO feed solution to the draw side in the PRO unit.

In another aspect of the present disclosure, which may be combined with any other aspect listed herein unless specified otherwise, the draw solution is concentrated by removal of water through electrolysis in the high pressure WE unit.

In another aspect of the present disclosure, which may be combined with any other aspect listed herein unless specified otherwise, the system further comprises a boosting pump to circulate the draw solution between the draw side of the PRO unit and the high pressure WE unit.

In another aspect of the present disclosure, which may be combined with any other aspect listed herein unless specified otherwise, a system for water electrolysis comprises a pressure retarded osmosis unit (PRO) including a semipermeable membrane having a feed side and a draw side, wherein the semipermeable membrane is housed in the PRO unit between a feed solution of contaminated water and a draw solution that has higher osmotic pressure and higher hydrostatic pressure than the osmotic pressure and the hydrostatic pressure of the feed side and a high pressure electrolyzer unit including an anode and a cathode, and a gas-impermeable divider or separator, coupled to the draw side of the pressure retarded osmosis unit.

In another aspect of the present disclosure, which may be combined with any other aspect listed herein unless specified otherwise, a spontaneous molecular water flow through the PRO membrane from the feed side to the draw side of the PRO unit augments a volumetric flow rate of the draw solution, and wherein an external energy requirement for circulating the draw solution between the PRO and the high pressure electrolyzer are lowered.

In another aspect of the present disclosure, which may be combined with any other aspect listed herein unless specified otherwise, the draw solution can include inorganic, organic, non-ionic agents, or one or more combinations of one or more of osmotic agent types or identifies, that facilitate high net positive osmotic pressure difference between draw side and feed side of the pressure retarded osmosis unit, at a pre-specified range of osmotic pressures, temperatures, flow rates, pH values, or hydrostatic pressures.

In another aspect of the present disclosure, which may be combined with any other aspect listed herein unless specified otherwise, the hydrostatic pressure of the draw solution is higher than a hydrostatic pressure of the feed solution and a hydrostatic pressure difference (ΔP) between the draw side and the feed side of the PRO is lower than a difference in osmotic pressures between the draw solution and the feed solution (Δπ).

In another aspect of the present disclosure, which may be combined with any other aspect listed herein unless specified otherwise, the draw solution is configured to flow between the draw side of the pressure retarded osmosis unit and the high pressure electrolyzer unit.

In another aspect of the present disclosure, which may be combined with any other aspect listed herein unless specified otherwise, the draw solution is diluted in the pressure retarded osmosis unit as a water is drawn into it from the feed side through the semipermeable membrane.

In another aspect of the present disclosure, which may be combined with any other aspect listed herein unless specified otherwise, the draw solution is concentrated in the high pressure electrolyzer unit as a water is removed by water electrolysis.

In another aspect of the present disclosure, which may be combined with any other aspect listed herein unless specified otherwise, a method for water electrolysis comprises providing an osmotic agent solution diluted by molecular water permeating through semipermeable membrane from a feed side to a draw side and applying a potential difference through an osmotic agent solution electrolyte in a high pressure electrolyzer unit having an anode and a cathode.

In another aspect of the present disclosure, which may be combined with any other aspect listed herein unless specified otherwise, the osmotic agent solution can include inorganic, organic, non-ionic agents, or one or more combinations of one or more of osmotic agent types or identifies, that facilitate high net positive osmotic pressure difference between draw side and feed side, at a pre-specified range of osmotic pressures, temperatures, flow rates, pH values, or hydrostatic pressures.

In another aspect of the present disclosure, which may be combined with any other aspect listed herein unless specified otherwise, the osmotic agent solution is configured to flow between a pressure retarded osmosis unit and the high pressure electrolyzer unit.

In another aspect of the present disclosure, which may be combined with any other aspect listed herein unless specified otherwise, the osmotic agent solution is diluted in the pressure retarded osmosis unit as a water is drawn into it from the feed side through the semipermeable membrane.

In another aspect of the present disclosure, which may be combined with any other aspect listed herein unless specified otherwise, the osmotic agent solution is concentrated in the high pressure electrolyzer unit as a water is removed by water electrolysis.

Additional features and advantages are described by way of example in, and will be apparent from, the following Detailed Description and the Figures. The figures are schematic and are not intended to be drawn to scale. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

Features and advantages of the present disclosure, including a process and system for indirect seawater electrolysis, described herein may be better understood by reference to the accompanying drawings in which:

FIG. 1 is a schematic diagram of an integrated PRO-High Pressure Electrolyzer hybrid system according to an embodiment of the present disclosure.

FIG. 2 illustrates LSV polarization plot for NV47 cathode in the osmotic agent electrolyte using 3-electrode cell configuration according to an embodiment of the present disclosure.

FIG. 3 illustrates chronoamperometry plots for cathodic NV47 in the osmotic agent electrolyte at 0.091 and 0.224 V (vs. RHE) using 3-electrode cell configuration according to an embodiment of the present disclosure.

FIG. 4 illustrates LSV polarization plot for CNF8-31 anode in the osmotic agent electrolyte using 3-electrode cell configuration according to an embodiment of the present disclosure.

FIG. 5 illustrates chronoamperometry plots for anodic CNF8-31 in the osmotic agent electrolyte at 1.432 and 1.672V (vs. RHE) using 3-electrode cell configuration according to an embodiment of the present disclosure.

The reader will appreciate the foregoing details, as well as others, upon considering the following detailed description of certain non-limiting embodiments of the present disclosure.

### DETAILED DESCRIPTION

The present disclosure is generally related to a process and system for water electrolysis utilizing seawater or other contaminated waters as feedstock.

Hydrogen gas (H₂) is a clean fuel that produces only water when combusted. H₂ can be produced from water electrolysis using renewable energy sources. Electrolysis is an established and well-known technology, constituting an effective technique for water splitting. Alkaline and polymer electrolyte membrane (PEM) electrolyzers are the two main technologies for splitting water into H₂ and oxygen (O₂). Both technologies are sensitive to water impurities and thus require purified water, which is usually obtained by purification of fresh water resources. However, using fresh water for water electrolysis is challenged in many countries facing increasing freshwater shortage. Thus, if seawater or impaired water can be utilized, it would provide a nearly unlimited water supply for H₂ production. Yet, direct electrolysis faces several major challenges when applied to seawater due to its complex composition.

Forward osmosis (FO) and pressure retarded osmosis (PRO) have received extensive attention during the last decade as emerging technologies for water reuse and saline water desalination, and power generation, respectively. These two engineered osmosis processes utilize spontaneous water transport driven by the net osmotic pressure difference across a semipermeable membrane placed between the feed saline water and a draw solution with a higher osmotic pressure. Unlike pressure-driven membrane processes such as reverse osmosis (RO), nanofiltration (NF), and even ultrafiltration (UF), FO requires minimum energy input, mainly for liquid circulation. However, a major challenge that limits commercial application of FO is the energy required for regeneration of the draw solution.

On the other hand, although PRO is capable of desalination, its main purpose has mostly been for power generation. It has been used to harness the osmotic energy of saline solutions, rather than to perform separation of salts. In PRO, a hydrostatic pressure (ΔP) is applied to the draw side of the PRO, and that pressure must be lower than the difference in osmotic pressures between the draw and feed (Δπ). By osmosis, water is drawn through the membrane against the hydrostatic pressure gradient. The effect of osmosis through the membrane is to augment the volumetric flowrate of the pressurized draw stream, which must be balanced by a blowdown stream. The blowdown can produce mechanical energy by passing it through a hydroturbine or to a pressure exchange network that transfers energy to a coupled process such as seawater reverse osmosis (SWRO). However, results of recent research work indicated that the application of PRO for power production is limited due to the energetic inefficiency. Yet, an alternative innovative application of PRO is integrating it with high-pressure water electrolyzers, rather than utilizing it for power production. This will allow the PRO to serve a dual-purpose: (i) removal of contaminants from seawater or impaired water; and (ii) maintaining the high-pressure of the electrolyzer feed without the need for external mechanical energy to pressurize it. The water flux across the PRO membranes would be less than that across the FO membrane due to the lower net driving force (Δπ-ΔP). However, the overall cost-effectiveness of providing both treated water and high-pressure to the WE is expected to be significant.

H₂ is usually stored or utilized at high pressure and thus, operating the WE at high pressure is desirable because it produces compressed H₂ gas. Therefore, operating the WE at high-pressure can significantly reduce the overall cost of H₂ production. Also, compression of liquid water feed to the WE is more efficient than compression of the gaseous products, and it results in smaller gas bubbles at the electrode surface in the WE, thus reducing the required overpotential. The operational pressure ranges for conventional water electrolyzers are consistent with the permissible pressure ranges for PRO membranes.

The present disclosure provides an innovative process integration between the PRO and the high-pressure WE in which seawater or other contaminated water source, can be utilized as the original water source for electrolysis, but no or minimum energy input is required for water desalination or for pressurizing the electrolyzer feed.

In some embodiments, the PRO draw solution is the WE electrolyte solution. The draw/electrolyte solution is circulated between the PRO and WE (PRO-WE hybrid system). It is diluted in the PRO unit as molecular water passes into it through the PRO membrane, and it is concentrated in the WE unit as water is removed by electrolysis. An advantage of the PRO-WE hybrid system is that the circulation of electrolyte solution at high pressure can eliminate the need for mechanical compression that would be required to pressurize the electrolyzer feed in conventional high-pressure electrolyzers. This is because the flow through the PRO membrane will raise and maintain pressure in the WE feed. However, a boosting pump might be required to circulate the electrolyte in the WE, but the energy required would be small.

Non-limiting embodiments of the present disclosure will be described by way of example with reference to the accompanying figures, which are not intended to be drawn to scale.

### Example 1

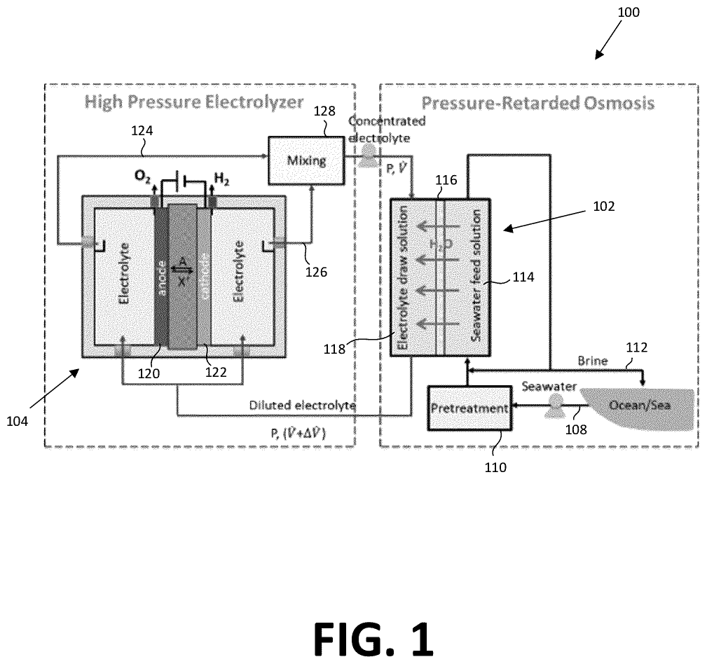

FIG. 1 shows a schematic diagram of an example of the integrated PRO-WE hybrid system.

As shown in FIG. 1, the water electrolysis system 100 includes a PRO unit 102 and a high-pressure WE unit 104 that processes an osmotic agent draw solution 106 in a closed loop. In some embodiments, seawater 108 undergoes a pretreatment process 110 prior to entering the PRO unit 102. According to a non-limiting embodiment, both seawater 108 and brine 112 enter the feed side of the PRO unit 102 creating a seawater feed solution 114. The brine 112 can be partially recycled back to the feed side of the PRO unit 102 or partially or entirely pass through into a waste stream. Within the PRO unit 102, molecular water in the feed solution side 114 spontaneously influxes through at least one semipermeable membrane 116 into the draw solution side 118. The draw solution 118, which is at a higher osmotic pressure and hydrostatic pressure than the feed solution 114, is diluted through molecular water influx from the feed solution side 114 and then enters the high pressure WE unit 104. Within the high pressure WE unit 104 is an anode 120 oxidizing water to oxygen in one compartment and a cathode 122 reducing water to hydrogen in another compartment creating an anolyte and catholyte effluent 124, 126. The effluents 124, 126 that exit the WE unit 104 return as a concentrated electrolytic solution into the PRO unit 102. In some embodiments, prior to returning to the PRO unit 102, the anolyte effluent 124 and the catholyte effluent 126 enters a mixer 128. In some embodiments, the oxygen produced at the anode 120 and hydrogen produced at the cathode 122 are removed from the anolyte and the catholyte effluents before they enter the mixer.

According to a non-limiting embodiment, the seawater feed stream 114 to the PRO unit 102 will be recycled as shown in FIG. 1 and the blowdown from the recycled loop and makeup fresh seawater can be controlled so that the flow across the PRO membrane 116 is equal to the flow of water being split in the WE to H₂ and O₂. As the water flux across the membrane 116 decreases due to membrane fouling, the flow rates of blowdowns can be increased to decrease the osmotic pressure of seawater 108 and subsequently increase the driving force for water flux across the membrane 116 (Δπ-ΔP).

Another advantage of the continuous recirculation of electrolyte solution between the PRO and the WE is that it can promote the removal of H⁺ and OH⁻ species produced on the anode 120 and cathode 122 surfaces, respectively, which enhances the OER and HER kinetics. Also, this mode of operation will not require H⁺ or OH⁻ transport between the anolyte and catholyte compartments, since H₂O is the main reacting species in both sides. Therefore, this operating scheme can allow for, albeit not in limiting application, replacing the relatively expensive ion exchange membranes with a less expensive gas-impermeable cell divider.

The disclosed process provides the benefit of operating the WE at. But not limited to, moderate pH conditions, unlike conventional electrolyzers, which operate at either acidic or alkaline conditions. There are practical benefits to avoiding strongly acid or alkaline electrolytes conventionally employed in the electrolyzer. These benefits include: (i) enabling the use of low-cost, earth-abundant electrocatalysts and inexpensive electrolyzer components that would normally deteriorate rapidly in highly acidic or alkaline environments; and (ii) minimizing environmental and safety issues related to handling strong acids or bases. Near-neutral and moderate pH operation has emerged as an alternative for water electrolyzers, because it is less corrosive, allows for broader options for catalyst materials, and offers safer operation. Yet, the kinetics of HER and OER are sluggish at neutral and near-neutral pH conditions due to the requirement of an additional water dissociation step to produce H⁺ and OH⁻.

Hydrogen produced by water electrolysis is stored or transported in the form of liquefied or pressurized gas. Therefore, operating the electrolyzer at high pressure will result in decreasing the additional amount of energy to further pressurize the produced hydrogen gas. Also, it is showed that the overall electrolysis system efficiency can be improved by increasing the electrolyzer operating pressure in the low-pressure region, which is the region within the range of practical PRO applied pressure on the draw solution side. This result is because the balance of plant (BOP) power consumption rapidly decreases as the early stage pressure increases.

### Example 2

According to an embodiment, the present disclosure discloses a process integration between the PRO unit 102 and high-pressure WE 104 in which seawater is utilized as the original water source for electrolysis. However, no energy input is required for water desalination or for pressurizing the electrolyzer 104, and only desalinated water electrolyte (the osmotic agent solution) flows through the electrolyzer 104. Water flows naturally across the PRO membrane 116 from the feed side (i.e., seawater) to the draw side (i.e., electrolyte solution) as a result of the net osmotic pressure difference (Δπ-ΔP) across the membrane 116. Also, no energy would be required for regenerating the draw solution 118, because the PRO unit 102 would be operated so that the amount of water transferred to the draw solution 118 is the same as the amount converted to H₂ and O₂ in the WE unit 104. This way, impurities present in seawater 108 will not enter the WE unit 104 because they will be rejected by the PRO membrane 116. Thus, no salt accumulation inside the WE unit 104 occurs and no blowdown from it will be required. The osmotic agent solution flows between the PRO unit 102 and the WE unit 104 in a closed loop as shown in FIG. 1.

According to an embodiment of the present disclosure, one feature of the present technology is the innovative process integration between the PRO unit 102 and high-pressure WE unit 104 in which seawater 108 is still utilized as the original water source for electrolysis, but no energy input is required for water desalination or for pressurizing the electrolyzer, and only desalinated water electrolyte flows through the WE unit 104. The osmotic agent solution flows between the PRO unit 102 and the WE unit 104 in a closed loop, serving as the PRO draw solution 118 and the WE electrolyte solution, as shown in FIG. 1. Also, this process does not require continuous disposal of concentrated electrolyte solutions (i.e., brine) from the WE unit 104 or release of contaminants into the environment. This is because no salt accumulation will occur inside the WE unit 104 and the electrolyte solution will flow in a closed loop between the WE unit 104 and the PRO unit 102, which would not be the case if seawater 108 were fed directly to the WE unit 104. This will not only save significant amounts of chemicals and cost, but it will also minimize waste disposal into the environment. Additionally, since the PRO membrane 116 will remove both major and minor ions, the electrodes, catalysts, and other WE components will be protected from poisoning or deterioration caused by seawater impurities. Furthermore, previous studies showed that increasing the concentration of the osmotic agent solution in the electrolyte/draw solution 118 leads to a proportional increase in the performance of the electrolysis process. Higher concentrations in the WE unit 104 will be desirable for the performance of the PRO unit 102 as well because they will promote high water flux through the PRO membrane 116. Moreover, the electrolyzer's high operating pressure can significantly improve the overall electrolysis system efficiency, in addition to its cost-effectiveness.

One feature of the present technology includes the utilization of seawater and impaired waters for electrocatalytic production of compressed hydrogen without external energy input for desalination or for pressuring the electrolyzer. Another feature of the present technology is that the process configuration allows seawater 108 to be used as the water source for electrolysis but only the diluted PRO draw solution 118 is fed to the WE unit 104. This avoids the problems associated with the chlorine evolution reaction and seawater impurities that adversely affect the performance of the electrolyzer 104 when seawater 108 is used as a water source without desalination. A third feature of the present technology is that no salt is accumulated in the electrolyzer 104 because salts are removed by PRO unit 102. A fourth feature of the present technology is that there is no high concentration waste discharge to the environment because the electrolyte solution flows in closed loop between the electrolyzer 104 and PRO units 102. A fifth feature of the present technology is that the HER and OER performances will not be controlled by the transfer of ions across the desalination membranes. This is because the desalination process occurs in the PRO unit 102, and thus the WE electrodes will not need to be separated by the desalination membranes 116. A sixth feature of the present technology is that the system maintains the buffering capacity of the electrolyte as a result of recombining the anolyte and catholyte effluents 124, 16 from the WE unit 104. The seventh feature of the present technology is that the possibility of replacing the relatively costly ion exchange membrane is a less expensive cell divider in the WE unit 104. Finally, an eighth feature of the present technology is that the controlled operation is without accumulation of salts inside the WE unit 104 and without the need for continuous disposal of concentrated electrolyte solutions from it.

According to another embodiment, osmotic pressure and pH at different concentrations and temperatures were calculated for some of the electrolytes. Results indicate the viability of the approach. For example, a mixture of 1.5 M potassium bicarbonate (KHCO₃) and 0.5 M potassium carbonate (K₂CO₃) in pure water at room temperature has an osmotic pressure of ˜83 bar and pH of 10.0±0.1. This osmotic pressure is more than 3 times the osmotic pressure of seawater, which is around 26 bar. This will result in a theoretical driving force (Δπ-ΔP) across the PRO membrane 116 of ˜37 bar when the pressure of the PRO-WE recycled stream is 20 bar. Although no available experimental data on the performance of potassium bicarbonate draw solutions in PRO unit 102, its performance as an osmotic agent in FO has been evaluated by previous researchers and it has shown very good performance. Bench-scale preliminary PRO experiments have been conducted using a mixture of potassium bicarbonate and potassium carbonate, with a concentration that has osmotic pressure more than three times that of seawater 108. The osmotic agent draw solution 118 was paired with synthetic seawater (35 g L-1 sea salt) as the feed solution in these PRO experiments. Commercial cellulose triacetate (CTA) flat sheet FO membranes were utilized in these experiments and they achieved an average flux of 5.1 L m⁻² h⁻¹ at an applied hydrostatic pressure of the draw solution of 20 bar. The data was used to make calculations of water demand and membrane area requirements for a hydrogen production plant with 100 MW capacity using the following assumptions: (i) ˜10 kg of water is required to produce 1 kg of H₂; and (ii) the electrolyzer energy efficiency is ˜65 kWh/kg-Hz.

For a 100 MW plant with an efficiency of 65 kWh/kg-H₂, the H₂ production rate would be ˜1,540 kg-H₂ h⁻¹, and the water consumption rate would be ˜15,400 L h⁻¹. For PRO membranes with a water flux of 5.1 L m⁻² h⁻¹, the required membrane area for this plant would be ˜3,020 m², which is equivalent to ˜1.97 m²/kg-H₂ h⁻¹ or ˜30 m²/MW.

### Example 3

According to an embodiment of the present disclosure, (Bi)carbonate salts have also shown good performance as electrolyte agents during water splitting. It was reported that different electrolyte species in a two-electrode configuration by using model cathode and anode of NiMo and CoOx/NF, respectively, which were electrochemically deposited on Ni foam (NF) were evaluated. Results showed that the optimal electrolyte was a solution of 1.5 mol potassium carbonate (50:50 KHCO₃/K₂CO₃), which achieved 10 mA cm⁻² at approximately 1.70 V with an onset voltage of less than 1.6 V and with excellent stability (>20 h) (See Shinagawa et al. ChemSusChem 2017, 10, 4155-4162).

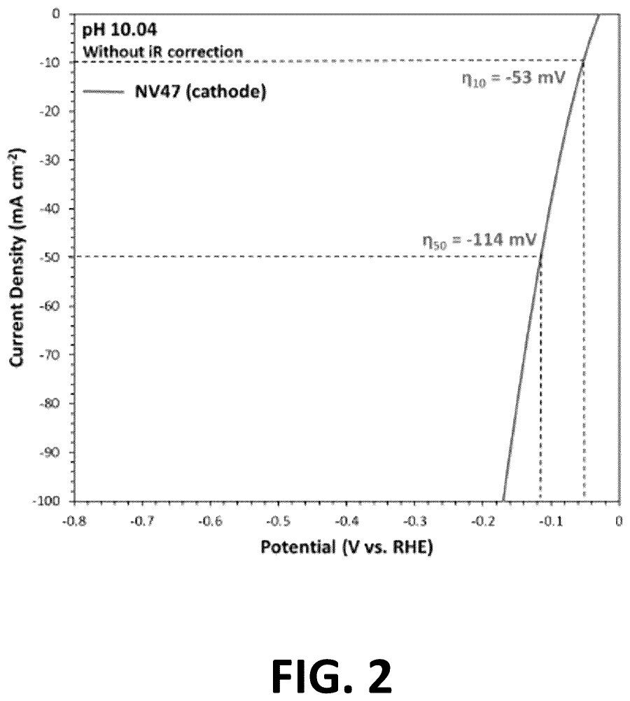

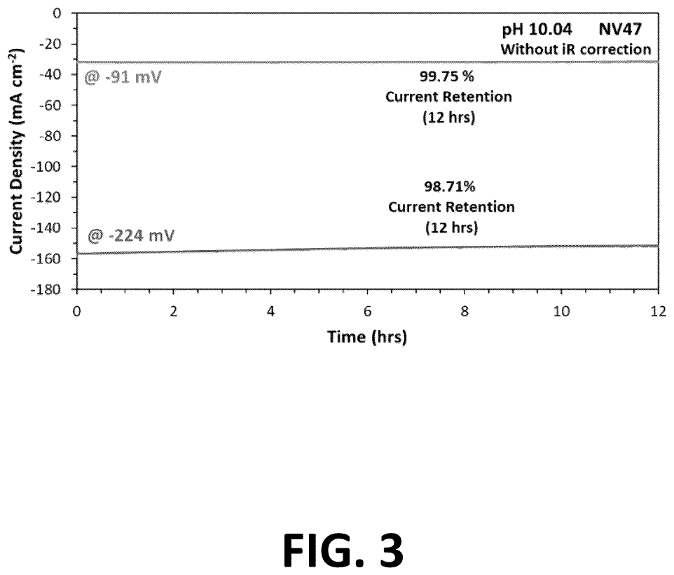

According to an embodiment of the present disclosure, electrochemical tests were performed in a gas-tight, three-electrode cell using an electrolyte solution, which is the draw solution produced in an FO experiment. This FO experiment was performed at the same conditions of the PRO experiment described above, except that no hydrostatic pressure on the draw side was applied. The catalysts utilized in the cell's cathode and anode were designed and fabricated in-house, and optimized for this specific application. Hereafter they will be referred to as NV47 (cathode) and CNF8-31 (anode). FIG. 2 shows the linear sweep voltammograms (LSVs) for HER using the osmotic agent electrolyte solution (i.e., draw solution produced in FO experiments) in a three-electrode configuration with NV47 as the cathode. The results presented in FIG. 2 show that current densities of −10 and −100 mA cm⁻² were achieved at applied potentials of ˜−0.053 and ˜−0.170 V (vs. RHE), respectively. Also, standard 12-hour chronoamperometry (CA) tests were performed using the same electrodes-electrolyte configuration to investigate whether current density remained constant when applied potential remained constant. The results are presented in FIG. 3 and show that current densities dropped a mere 0.25% and 1.31% at applied potentials of −0.091 and −0.224 V (vs. RHE), which provided current densities of −31 and −158 mA cm⁻², respectively.

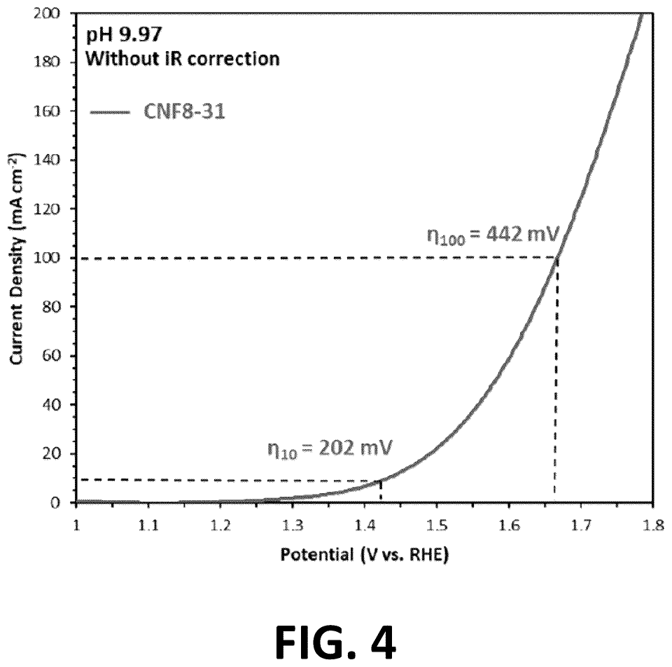

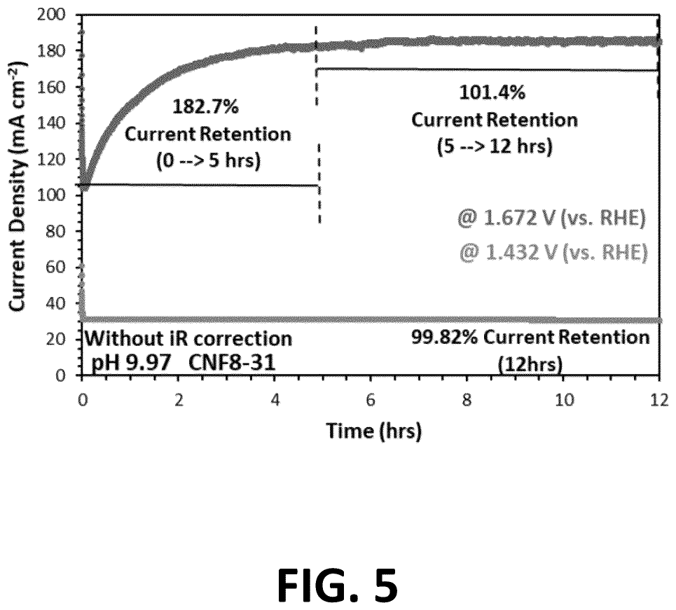

Similarly for OER, the developed CNF8-31 anodic electrode in the osmotic agent electrolyte was used, and achieved 10 and 100 mA cm⁻² of current densities at 1.432 and 1.672 V (vs. RHE), shown in FIG. 4. CA stability tests for 12 hours resulted in a 1.2% drop in the initial current density at an applied potential of 1.432 V (vs. RHE). Operating at higher potential (1.672 V vs. RHE) for 12 hours resulted in an initial 82.7% increase in current density over approximately the first 5 hours, followed by a steady 1.4% increase in performance for the remaining 7 hours, shown in FIG. 5. Thus, the initial current density of −100 mA cm⁻² steadied out to a final value of 184.9 mA cm⁻² at the applied potential of 1.672 V (vs. RHE). This behavior was likely due to favorable surface modulation between the anode and electrolyte. These results indicate that the system performance is better than reported in the literature at similar pH (See Shinagawa et al. ChemSusChem 2017, 10, 4155-4162). Furthermore, gas chromatography (GC) measurements were performed to quantify the evolved H₂ and O₂ at specific time intervals during NV47 and CNF8-31 electrochemical CA testing, respectively, in the same electrolyte solution. The measured gas concentrations were used to calculate Faradaic efficiencies (FE) of both the cathode and anode developed in-house. Under cathodic potentials of −0.091 and −0.224 V (vs. RHE), the NV47 exhibited average FEs of 92.9 and 90.6%, respectively, whilst under anodic potentials of 1.432 and 1.672 V (vs. RHE), CNF8-31 achieved average FEs of 95.6 and 83.8%, respectively.

The obtained electrochemical results are quite comparable to contemporary and benchmark cathodic and anodic electrocatalysts developed for conventional alkaline water electrolytes. It was reported that HER overpotential in alkaline (1M KOH) pH of −26 mV to achieve −10 mA cm⁻² of current density (See Zhou et al. Nature Commun. 2021, 12, 3783). These results compare well with the NV47 cathode tested at a moderate pH of 10.04 using the osmotic agent electrolyte. As mentioned previously, this system required −91 mV to achieve a current density of −31 mA cm⁻². Thus, the NV47 cathode demonstrated cathodic H₂ evolution efficacy that is competitive with the electrocatalytic performance of contemporary noble metal-based cathodes operating at harsh pH conditions. Also, the in-house developed CNF8-31 anodic catalyst required 442 mV of overpotential to achieve 184.9 mA cm-2 of current density using the osmotic agent electrolyte solution at pH 9.97. Again, this electrocatalytic performance is competitive with ultra-active anodes being developed. For instance, NiFe layered double hydroxide on porous nickel foam (Ni/NiFe LDH) was reported to achieve a current density of 100 mA cm⁻² at 237 mV in alkaline electrolytes (See Ning et al. Materials Today Physics 2021, 19, 100419).

According to an embodiment of the present disclosure, the present technology can create a commercial product for utilizing seawater and impaired waters for electrocatalytic production of pressurized hydrogen. Electrochemical water splitting is a well-developed technology that has been studied and applied widely. It shows excellent adaptability and can efficiently produce H₂ and O₂ via WE devices using electrical power, which can be produced from renewable energy sources. The main components of the commercial product will be a high-pressure electrolyzer with the in-house developed electrode materials, PRO modules housing the proper membranes, and the osmotic agent electrolyte that: (i) achieves electrolysis conditions for both HER and OER inside the WE that provide for efficient water splitting at low potential; and (ii) achieves reasonable water flux and low reverse salt diffusion through the PRO membranes.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

In some embodiments, the draw side can be comprised of one, or a combination of two or more, solution that includes, but is not limited to, inorganic, organic, and non-nonionic draw solutes with an osmotic pressure that is greater than or equal to 10 bar, greater than or equal to 20 bar, greater than or equal to 30 bar, greater than or equal to 40 bar, greater than or equal to 50 bar, greater than or equal to 60 bar, greater than or equal to 70 bar, greater than or equal to 80 bar, greater than or equal to 90 bar, greater than or equal to 100 bar, greater than or equal to 150 bar, greater than or equal to 200 bar, greater than or equal to 300 bar, greater than or equal to 400 bar, or greater than or equal to 500 bar. In some embodiments the draw solution is under an osmotic pressure of less than or equal to 500 bar, less than or equal to 400 bar, less than or equal to 300 bar, less than or equal to 200 bar, less than or equal to 150 bar, less than or equal to 100 bar, less than or equal to 90 bar, less than or equal to 80 bar, less than or equal to 70 bar, less than or equal to 60 bar, less than or equal to 50 bar, less than or equal to 40 bar, less than or equal to 30 bar, less than or equal to 20 bar, or less than or equal to 10 bar. Combinations of the above-reference ranges are also possible (i.e., greater than or equal to 60 bar and less than or equal to 150 bar). Other ranges are similarly also possible.

In some embodiments, the PRO feed and draw solutions and WE systems can be operated at temperatures that are greater than or equal to 283 K, greater than or equal to 293 K, greater than or equal to 303 K, greater than or equal to 313 K, greater than or equal to 323 K, greater than or equal to 333 K, greater than or equal to 343 K, greater than or equal to 353 K, greater than or equal to 363 K, or greater than or equal to 373 K. In some embodiments the PRO feed and draw solutions and WE system can be operated at temperatures that are less than or equal to 373 K, less than or equal to 363 K, less than or equal to 353 K, less than or equal to 343 K, less than or equal to 333 K, less than or equal to 323 K, less than or equal to 313 K, less than or equal to 303 K, less than or equal to 293 K, or less than or equal to 283 K. Combinations of the above-reference ranges are also possible (i.e., greater than or equal to 303 K and less than or equal to 353 K on opposing sides of the semipermeable PRO membrane or between the WE and PRO systems). Other ranges are also possible.

In some embodiments, the hydrostatic pressure applied to the PRO draw side, and by default the WE, can be operated at gauge pressures that are greater than or equal to 1 bar, greater than or equal to 10 bar, greater than or equal to 20 bar, greater than or equal to 30 bar, greater than or equal to 40 bar, greater than or equal to bar, greater than or equal to 60 bar, greater than or equal to 70 bar, greater than or equal to 80 bar, greater than or equal to 90 bar, or greater than or equal to 100 bar. In some embodiments, the hydrostatic pressure applied to the PRO draw and WE can be at gauge pressures less than or equal to 100 bar, less than or equal to 90 bar, less than or equal to 80 bar, less than or equal to 70 bar, less than or equal to 60 bar, less than or equal to 50 bar, less than or equal 40 bar, less than or equal to 40 bar, less than or equal to 30 bar, less than or equal to 20 bar, less than or equal to 10 bar, less than or equal to 5 bar. Combinations of the above-reference ranges are also possible (i.e., greater than or equal to 10 bar and less than or equal to 80 bar). Other ranges are also possible.

In some embodiments, the draw solution pH, and therefore by default the WE electrolyte pH, can be greater than or equal to 0, greater than or equal to 1, greater than or equal to 2, greater than or equal to 2, greater than or equal to 3, greater than or equal to 4, greater than or equal to 5, greater than or equal to 6, greater than or equal to 7, greater than or equal to 8, greater than or equal to 9, greater than or equal to greater than or equal to 11, greater than or equal to 12, greater than or equal to 13, or greater than or equal to 14. In some embodiments, the draw solution and WE electrolyte pH can be less than or equal to 14, less than or equal to 13, less than or equal to 12, less than or equal to 11, less than or equal to 10, less than or equal to 9, less than or equal to 8, less than or equal to 7, less than or equal to 6, less than or equal to 5, less than or equal to 4, less than or equal to 3, less than or equal to 2, less than or equal to 1, or less than or equal to 0. Combinations of the above-reference ranges are also possible (i.e., non-equal Faradaic efficiencies in the WE due to subpar catalysts and/or electrolyzer designs may result in a slight increase or decrease of pH in the WE relative to that fed from the PRO draw side).

In some non-limiting embodiments, the disclosure captains any configurations and system components that combine PRO with electrolyzers under which any stream from the PRO to the electrolyzer, or from the electrolyzer to the PRO, enter the opposing unit (PRO or electrolyzer) directly or indirectly.

In some embodiments, the semipermeable membrane used for the PRO unit can include flat sheet membranes, hollow fiber membranes, spiral wound membranes, tubular membranes, composite membranes, thin film composite membranes, hollow sheet membranes, composite hollow fiber membranes, nanocomposite membranes, thin film nanocomposite membranes, zeolite membranes, graphene-based membranes, ceramic membranes, or ion exchange membranes or forward osmosis membranes retrofitted for PRO application, or one or more combinations of the aforementioned.

In some embodiments, the WE can be alkaline electrolyzers, proton exchange membrane electrolyzers, photoelectrochemical cells, bipolar membrane water electrolyzers, flow electrolyzers, solid oxide electrolyzer cells, membraneless electrolyzers, hydroxide exchange membrane electrolyzers, or any combination of the aforementioned configured in series or parallel that rely partly or in full on source water obtained from contaminated water desalination or treatment through the described PRO process.

In some embodiments, the divider in the WE can comprise of a gas-nonpermeable divider or baffle, or ion exchange membranes including proton exchange membranes, anion/hydroxide exchange membranes, bipolar membranes, whereby the latter can, but does not necessarily need to, contain a water dissociation catalyst.

In some embodiments, the WE can operate at current densities greater than or equal to 10 mA cm⁻², greater than or equal to 50 mA cm⁻², greater than or equal to 100 mA cm⁻², greater than or equal to 250 mA cm⁻², greater than or equal to 500 mA cm⁻², greater than or equal to 750 mA cm⁻², greater than or equal to 1 A cm⁻², greater than or equal to 2 A cm⁻², or greater than or equal to 4 A cm 2, irrespective of the applied potential difference which would be a function of non-limiting electrolyzer types and/or electrode efficiencies. In some embodiments, the WE can operate at current densities less than or equal to 4 A cm⁻², less than or equal to 2 A cm⁻², less than or equal to 1 A cm⁻², less than or equal to 750 mA cm⁻², less than or equal to 500 mA cm⁻², less than or equal to 250 mA cm⁻², less than or equal to 100 mA cm⁻², less than or equal to 50 mA cm⁻², or less than or equal to 10 mA cm⁻², irrespective of the applied potential difference which would be a function of non-limiting electrolyzer types and/or electrode efficiencies. Combinations of the above-reference ranges are also possible (i.e., greater than or equal to 500 mA cm⁻² and less than or equal to 1 A cm⁻²). In some embodiments, the WE can operate with bifunctional electrocatalysts for both HER and OER, or specialized anodic OER and specialized cathodic HER electrocatalysts including, but not limited to, benchmark platinum-group metal (PGM) anodic iridium-ruthenium oxides or nickel-iron oxides or benchmark PGM platinum based cathodes, or other earth-abundant oxides, carbides, nitrides, sulfides, phosphides, selenides, or carbon-based/supported electrocatalysts for HER and OER.

In some embodiments, the WE system can operate with one electrolyzer type at greater than or equal to 10, greater than or equal to 20, greater than or equal to greater than or equal to 100, or greater than or equal to 500 electrolyzers connected to the draw side of the PRO unit in recirculation with previously noted non-limiting conditions of draw identity, osmotic pressures, temperatures, pH environments, or hydrostatic pressures. H₂ production capacity needs of the electrolysis plant would determine the needed number of electrolyzer stacks and corresponding cells for each stack. Similarly, in some embodiments, the WE system can operate with one electrolyzer type at less than or equal to 500 electrolyzers, less than or equal to 100, less than or equal to 50, less than or equal to 20, or less than or equal to 10 electrolyzers. Combinations of the above-reference ranges are also possible (i.e., greater than or equal to 50 electrolyzers and less than or equal to 100 electrolyzers).

The invention is claimed as follows:

1. A system for water electrolysis, comprising:
a pressure retarded osmosis unit (PRO) including a semipermeable membrane having a feed side and a draw side, wherein the semipermeable membrane is housed in the PRO unit between a feed solution of contaminated water and a draw solution that has higher osmotic pressure and higher hydrostatic pressure than the osmotic pressure and the hydrostatic pressure of the feed side; and
a high pressure electrolyzer unit including an anode and a cathode, and a gas-impermeable divider or separator, coupled to the draw side of the pressure retarded osmosis unit.

2. The system of claim 1, wherein a spontaneous molecular water flow through the PRO membrane from the feed side to the draw side of the PRO unit augments a volumetric flow rate of the draw solution, and wherein an external energy requirement for circulating the draw solution between the PRO and the high pressure electrolyzer are lowered.

3. The system of claim 1, wherein the draw solution can include inorganic, organic, non-ionic agents, or one or more combinations of one or more of osmotic agent types or identifies, that facilitate high net positive osmotic pressure difference between draw side and feed side of the pressure retarded osmosis unit, at a pre-specified range of osmotic pressures, temperatures, flow rates, pH values, or hydrostatic pressures.

4. The system of claim 1, wherein the hydrostatic pressure of the draw solution is higher than a hydrostatic pressure of the feed solution and a hydrostatic pressure difference (ΔP) between the draw side and the feed side of the PRO is lower than a difference in osmotic pressures between the draw solution and the feed solution (Δπ).

5. The system of claim 1, wherein the draw solution is configured to flow between the draw side of the pressure retarded osmosis unit and the high pressure electrolyzer unit.

6. The system of claim 1, wherein the draw solution is diluted in the pressure retarded osmosis unit as a water is drawn into it from the feed side through the semipermeable membrane.

7. The system of claim 1, wherein the draw solution is concentrated in the high pressure electrolyzer unit as a water is removed by water electrolysis.

8. A method for water electrolysis, comprising:
providing an osmotic agent solution diluted by molecular water permeating through semipermeable membrane from a feed side to a draw side; and
applying a potential difference through an osmotic agent solution electrolyte in a high pressure electrolyzer unit having an anode and a cathode.

9. The method of claim 8, wherein the osmotic agent solution can include inorganic, organic, non-ionic agents, or one or more combinations of one or more of osmotic agent types or identifies, that facilitate high net positive osmotic pressure difference between draw side and feed side, at a pre-specified range of osmotic pressures, temperatures, flow rates, pH values, or hydrostatic pressures.

10. The method of claim 8, wherein the osmotic agent solution is configured to flow between a pressure retarded osmosis unit and the high pressure electrolyzer unit.

11. The method of claim 8, wherein the osmotic agent solution is diluted in the pressure retarded osmosis unit as a water is drawn into it from the feed side through the semipermeable membrane.

12. The method of claim 8, wherein the osmotic agent solution is concentrated in the high pressure electrolyzer unit as a water is removed by water electrolysis.
